(19) United States
(12) Patent Application Publication
(10) Pub. No.: US 2021/0129885 A1
(43) Pub. Date: May 6, 2021

(54) SHOPPING BAG AND TISSUE DISPENSER APPARATUS

(71) Applicant: Jesse Roper, Hawthorne, CA (US)

(72) Inventor: Jesse Roper, Hawthorne, CA (US)

(21) Appl. No.: 16/924,072

(22) Filed: Jul. 8, 2020

Related U.S. Application Data
(63) Continuation-in-part of application No. 16/675,591, filed on Nov. 6, 2019.

(51) Int. Cl. B62B 3/14; A47K 10/20; B65D 33/00

(52) U.S. Cl. CPC B62B 3/1472; B65D 33/001; A47K 10/20

(57) ABSTRACT

A bag having front and back walls, including an outlet opening covered by a hinged door. A pocket behind the opening for receipt of a tissue dispenser to positioned a tissue outlet in the opening.

### CROSS-REFERENCES TO RELATED APPLICATIONS

This application is a continuation-in-part of U.S. patent application Ser. No. 16/675,591, filed Nov. 6, 2019 incorporated by reference in its entirety.

### BACKGROUND

Shoppers have long used plastic bags which are typically discarded after a single use. The problem with the plastic shopping bags has been long known. Plastic bags are manufactured from fossil fuels and end up as waste in landfills and on the ocean floor. Birds, fish, turtles, and other animals often intentionally or unintentionally ingest plastic bags or the remnants thereof, a characteristic which can transfer up the food chain to bigger fish and marine mammals.

It has been said that Americans use 100 million plastic bags per year manufactured from some 12 million barrels of oil. The average American family takes home almost 1,500 plastic shopping bags per year and published data suggests that only about 1% are recycled. Some 80% of ocean plastic pollution enters from land each year affecting hundreds of different species resulting in the death of some 100,000 marine animals when deposited in a landfill. It will take more than 500 years for each plastic bag to degrade and, even then, the bags do not break down completely. The problem with plastic bags has become so acute that some municipalities have banned certain disposable bags and in some municipalities stores are required to charge consumers a deposit on each disposable bag.

In recognition of the problem, numerous different styles of disposable bags have been proposed over the years. One of the drawbacks of disposable bags is the fact that special attention must be given to a construction which will provide for the mouth of the bag to remain open. One such construction proposed includes a hem around the upper portion of the sidewalls of the bag to act as a stiffening member. Construction of this type is disclosed in U.S. Pat. No. 9,604,757 to Spivack. Such bags, while offering benefits, have the drawback that constructing with a stiffening hem adds to the expense of manufacture and, in practice, such hems often fail to afford the degree of stiffening necessary for maintaining the mouths of such bags open during the filling operation.

Single-use plastic packaging is a mounting problem, both environmentally and economically. This packaging fills our stores and remnants are in our clothing which sheds microplastic fibers in the wash.

Published data indicates that in this century more plastic was made than in history up to the year 2000. Every year billions of pounds of plastic end up in the world's oceans. Studies estimate that there are now 15-51 trillion pieces of plastic in the world's oceans. It is believed that not a single square mile of the ocean anywhere is free of plastic pollution. The fossil fuel industry indicates it plans to increase plastic production by 40% over the next decade. Oil giants are rapidly building petrochemical plants across the nation to turn fracking gas into the plastic. This means more plastic in our oceans.

Plastic is durable. The EPA reports that every bit of plastic ever made still exists. All five of the earth's major ocean gyres are inundated with plastic pollution as demonstrated by the Great Pacific Garbage Patch. It is understood that fish in the North Pacific ingest 12,000 to 24,000 tons of plastic each year. A published study found that a quarter of fish at markets in California contained plastic in their intestines mostly in the form of plastic microfibers. Sea birds ingest plastic every day. Plastic ingestion reduces the storage volume of the stomach causing starvation. It is estimated that 60% of the seabird species have eaten pieces of plastic.

Various nations have sought to tackle the problem and the US Environmental Protection Agency has asked the government to regulate plastics as a pollutant under the Clean Water Act. Thus, there exists a critical demand for reusable plastic bags.

With the advent of the coronavirus pandemic, the need for practices to prevent the spread of the virus has taken on an even greater significance. The transfer for many decades it has been recognized that the cleansing of hands made by surgeons protect transmission of infection of one patient to another. Ignaz Semmelweis, a Hungarian doctor working Vienna General Hospital, is known as a father of hand hygiene. As early 1846, he noticed that women giving in the medical student/doctor-run maternity ward in his hospital were much more likely to develop a fever and die compared to women giving birth in the adjacent midwife-run maternity ward. Thus, investigating the differences, he noticed that doctors and medical students often visited the maternity ward directly after performing an autopsy. Based on this observation, he developed a theory that those performing autopsies got “cadaverous particles” on their hands, which they then carried from the autopsy room to the maternity ward.

As a result, Semmelweis imposed a new rule mandating handwashing with chlorine for doctors. The rates of death in his maternity ward fell dramatically. This was recognized as proof that cleansing hands would prevent infection. A few years later in Scutari, Italy, the Crimean War brought about a new handwashing champion, Florence Nightingale. At a time when most people believed that infections were caused by foul odors called miasmas, Florence Nightingale implemented handwashing and other hygiene practices in the war hospital where she worked. This practice achieved a reduction in infections.

It was not until 1980′s, when a string of foodborne outbreaks and healthcare-associated infections led to public concern that the United States Center for Disease Control and Prevention (CDC) identified hand hygiene as an important way to prevent the spread of infection. In doing so, the heralded the first nationally endorsed hand hygiene guidelines, and many more have followed.

In recent years, handwashing with soap and other forms of hand hygiene have been gaining recognition as a cost-effective, essential tool for achieving in good health nutrition. Now that its effectiveness is no longer in question, the main focus is on how to make handwashing universal. This challenge-sustained handwashing practice at key times, is being met with new thinking about behavior change, such as habit formation and nudges, increasing research into the impact of hygiene.

Publications have recognized that handwashing can save lives. It is stated that key time to wash hands is (1) before, during, and after preparing food; (2) before eating; (3) before and after caring for someone at home who is sick with vomiting or diarrhea; (4) before and after treating a cut or wound; (5) after using the toilet, (6) after changing diapers or cleaning up child who has used the toilet; (7) after blowing your nose, coughing, or sneezing; (8) after touching an animal, animal feed, or animal waste; (9) after handling pet food or pet treats; and (10) after touching garbage. Of course, during these times the individual does not always have access to soap and water for handwashing. Rather, the use of treated or untreated tissue has been recognized as a ready defense against transmission spread of disease and virus.

The overall challenges have been compounded by the spread coronavirus throughout the U.S.A., and indeed throughout the world. The number of reported coronavirus cases in the United States has surpassed 1.8 million, including more than 100 thousand deaths.

It is recognized that the disease may be spread by touching, products and items which have been touched by diseased individual. This is particularly concerning in the store were products are on display and customers have a tendency to pass along the aisles between display racks and often times reach out and touch squeeze the packages or manipulate same for a better view of the text displayed there on.

Many shoppers recognize the benefits of washing and sanitizing their hands, there is a need for a reminder to the shoppers to cleanse and sanitize their hands and for ready access to wipes which may be utilized for whipping down the user's hands or products to be purchased.

### SUMMARY OF THE INVENTION

The present invention includes a clamp for suspending a reusable flexible open top container bag from a shopping cart or the like and incorporates a horizontal spreader rod attached to the top of the container bag to hold the back wall spread and allow the from wall to distend leaving the top of the bag open for convenient access and includes a window in the front wall exposed for dispensing tissues from a pocket disposed there behind.

### DESCRIPTION OF PRIOR ART

It has been proposed to mount a pair of parallel arms cantileverally from a wall, spaced apart for receipt of clips which might clip to the opposite side walls of a bag. A device of this type is shown in U.S. Pat. No. 2,875,970 to Gardner. While beneficial for static applications, the separate arms and clip arrangement shown would not perform well for mounting disposable bags from a sidewall of a shopping cart.

It has also been proposed to provide the hooks or loops for suspending a bag from the side of a shopping cart. A device of this type is shown in U.S. Publication No. 2010/0320246 to Taylor. This device fails to provide firm or rigid support to hold the top of a flexible container bag open for convenient use in storing and deploying a supply of reusable shopping bags.

It has been known to provide a container for multiple shopping bags to be deployed from a folded position as disclosed in U.S. Pat. No. 5,046,860 to Brennan and U.S. Pat. No. 5,182,895 to Lugo. While providing containment for folded shopping bags, such devices fail to incorporate acceptable structure for suspending a flexible shopping bag container from a shopping cart in such a way as to maintain the container bag in an open orientation for convenient access to folded reusable shopping bags contained therein.

### BRIEF DESCRIPTION OF THE DRAWINGS

FIG. 1 is a perspective view of a reusable shopper bag hanger device incorporated in the present invention;

FIG. 2 is a front view thereof, partially cut away;

FIG. 3 is a top, side perspective view, in reduced scale, of the device of FIG. 1 suspended from a shopping cart;

FIG. 4 is a top perspective view, in an enlarged scale, of the device shown in FIG. 3;

FIG. 5 is a top perspective view of a second embodiment of the combination shopping bag and disinfectant wipes of the present invention;

FIG. 6 is a vertical sectional view, in enlarged scale, taken along the lines 66-67 of FIG. 5;

FIG. 7 is a front view, in reduced scale, showing the combination shopping bag and the sanitizing wipe dispenser of FIG. 5 suspended from a shopping cart;

FIG. 8 is a front view similar to FIG. 7 but in reduced scale and showing a top opening of an incorporated pocket; and

FIG. 9 is a front view similar to FIG. 8.

### DETAILED DESCRIPTION OF THE PREFERRED EMBODIMENTS

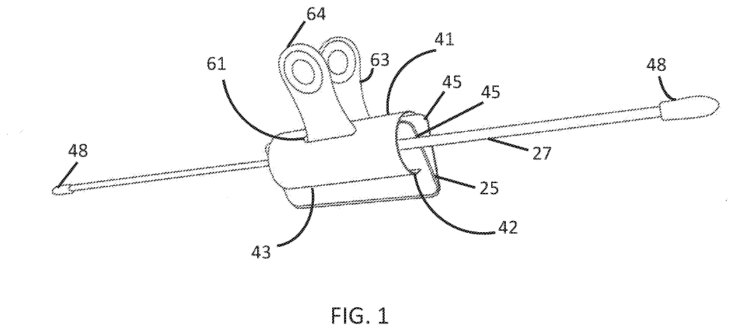

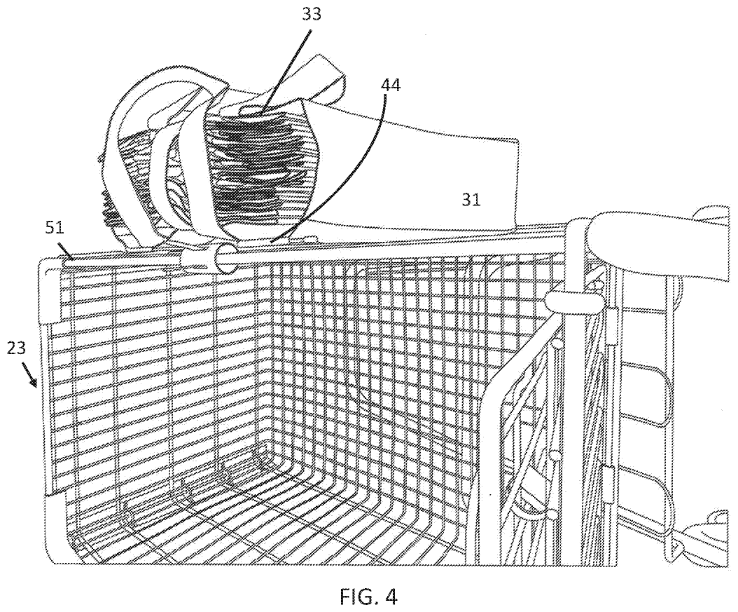

Referring to FIGS. 1 and 4, the reusable tote bag of the present invention includes a cart hanger device which may incorporate a clip device 21 at the top for clipping the top of the back wall to the side of a shopping cart 23 and an interior pocket 65 to hold a tissue packet 70.

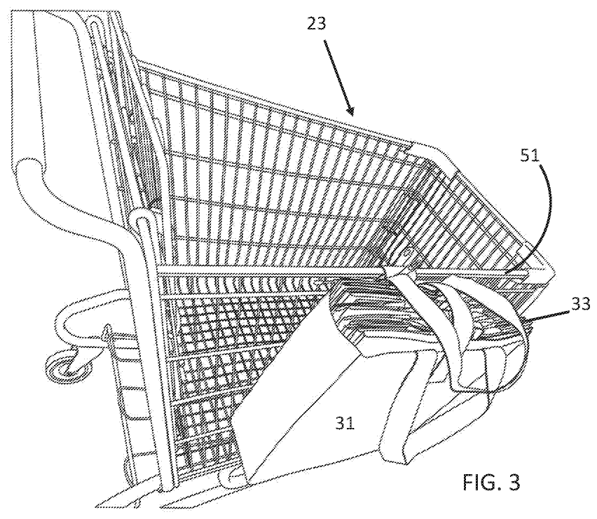

The clip device includes a clip 25 carrying a horizontally projecting rigid hanger rod 27 for suspension and spreading the back wall of a flexible shopping container bag 31. The bag 31 may itself contain a plurality of folded flexible reusable shopping bags 33 (FIG. 3) for ready access by a shopper. The back wall of the container bag is formed along its upper edge with a pair of spaced apart horizontal sleeves 44 (FIG. 4) for receiving the opposite lengths of the spreader rod

Grocery stores and the like have offered a supply of plastic bags of various configurations to group groceries purchased by customers. The appetite for discardable plastic bags has grown over the years Despite encouragement to do so, customers seldom retain shopping bags for reuse, particularly those of flimsy construction and prone to damage, ripping and failure. The demand for a device for carrying and deploying reusable shopping bags for ready use has long existed. Busy consumers on a grocery shopping trip have little time to locate and arrange shopping bags for ready use in a manner that will encourage reuse thereof. It is thus important that a device for carrying and dispensing reusable shopping bags to a busy shopper be convenient to use, efficient to load, and constructed for ready presentation and deployment of numerous shopping bags which might be needed during a grocery shopping trip. It is this objective to which the present invention is directed.

My bag itself may be contracted fabric, vinyl fabric, canvas, close -woven cotton duck, linen or any other fabric or plastic material well known in the art.

In my preferred embodiment, I incorporate a spring clip device 21 including an elongated split cylindrical spring barrel 41 open along one side to terminate in opposite longitudinal, confronting edges 43 which press radially inwardly against the medial outside surfaces of respective rectangular clamp plates 45 arranged in V-fashion to press the distal edges thereof together for clamping over an item such as the top bar 51 of a shopping cart 23 (FIG. 3). The plates 45 are affixed to the clip edges 43 by glue 42 (FIG. 1) or similar fastening material. The back edges 40 of the plates abut the back wall of the spring barrel to be partially supported thereby.

The barrel 41 is formed in its backside with cylindrically, radially spaced apart, parallel slots 61 through which respective elongated divergent ears 63 project to form pressure tabs 64 for access by the operator. The convergent ends of the ears 63 project through the radially spaced apart longitudinal slots 61 in the barrel 41 to engage confronting edges medially with the respective plates 45 for, upon relax of the barrel 41, press the distal edges of the plates together. In my preferred embodiment, I incorporate cushioning caps 48 on the opposite ends of the rod 27 (FIG. 1).

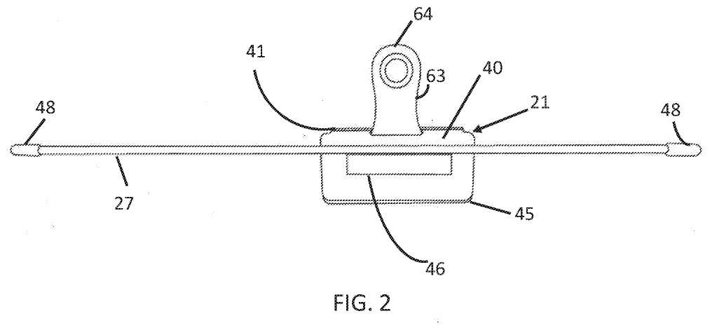

For my preferred embodiment, I selected the barrel, pressure plates, and rod all of ferromagnetic material and select magnets 46 (FIG. 2) with a rectangular construction to fit in the space outside the pressure plate 45 and within the confines of the barrel such that the magnet forms a magnetic field around the barrel, pressure plate, and rod thereby releasably maintaining the magnet and rod in their selected positions for convenient adjustment and support of reusable bags hung from the rod. My work has proven that the described construction is economical to manufacture and performs well in practice.

In operation, it will be appreciated that the shopper may conveniently carry the suspension device and the container bag 31 into the store to retrieve a shopping cart 23 and suspended the device over the top rail 51 of the cart 23 (FIG. 3). With the device so suspended and the opposite extremities of the rod 27 received in the respective bag sleeves 44(FIG. 4) the proximal wall of the bag 31 will be spread in a vertical plane along the sidewall of the cart 23 to allow the distal wall of such container bag to deploy outwardly and expose the folded bags 33 carried therein for ready access as the shopper moves about the store collecting items for purchase and deposit in the bags carried in the basket.

Grocery items selected may be selectively placed in the selected reusable bags and the loaded bags place in the hold of the shopping cart for presentation at the check-out counter. As the items are retrieved and checked by the cashier or by the customer, they may be placed back in the respective bags to be conveniently transported by a cart or otherwise to the shopper's automobile trunk or SUV passenger compartment. The bags may be then be placed in the trunk or backseat and the shopping cart returned to the return area.

Upon arriving home, the respective bags 33 filled with groceries may be transported to the kitchen or pantry area for unloading. As the respective bags are unloaded, they may be again folded in accordion fashion and placed back in the container bag 31 to be stored for subsequent use in the next trip to the grocery store.

From the foregoing, it will be apparent that the reusable shopping bag apparatus for the present invention is economical to manufacture, convenient to use, and will serve to attract ready and convenient use by everyday shoppers to encourage.

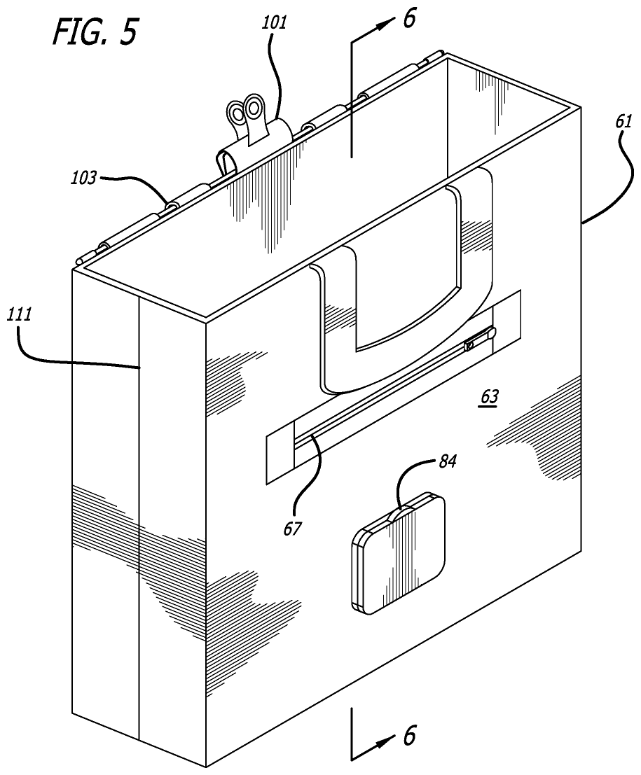

Referring to FIGS. 5-9, a second embodiment of the present invention includes a shopping bag 61 having a front wall 63 with a pocket 65 formed there behind and including a zipper opening 67 at the top.

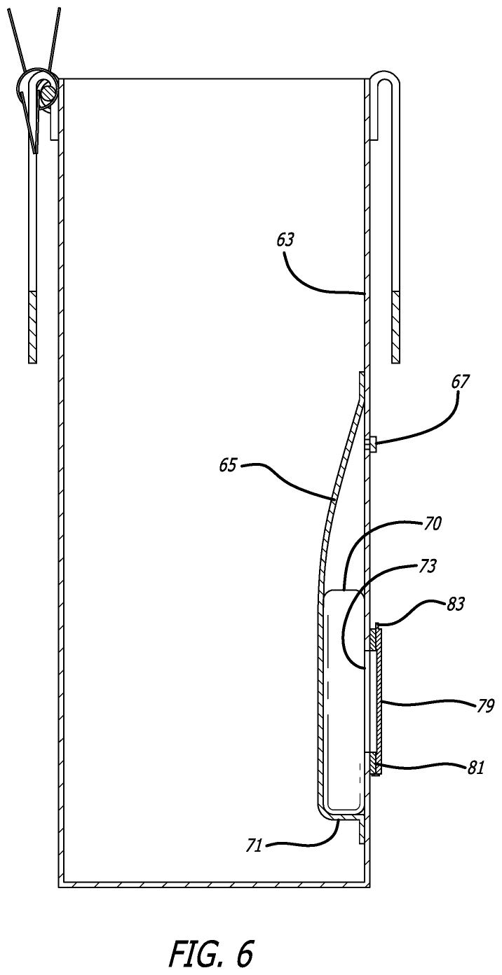

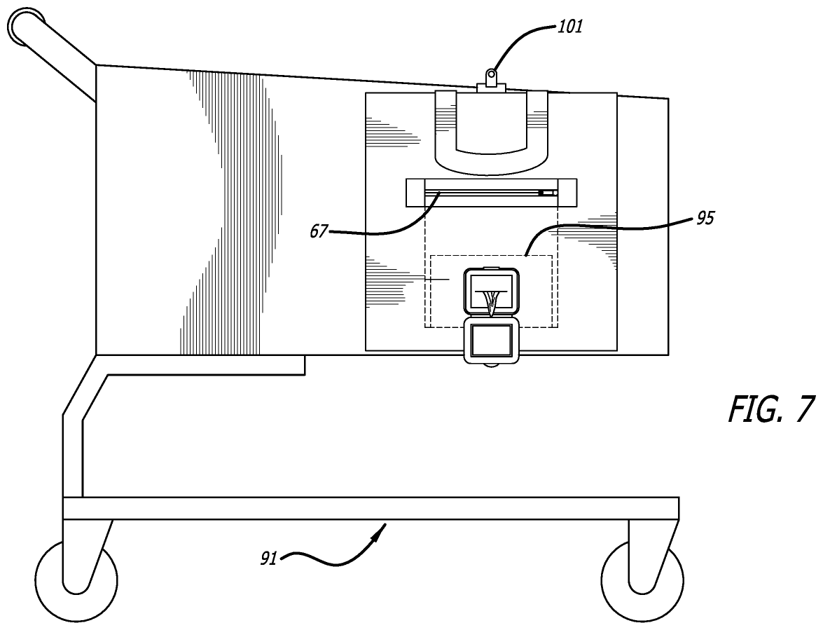

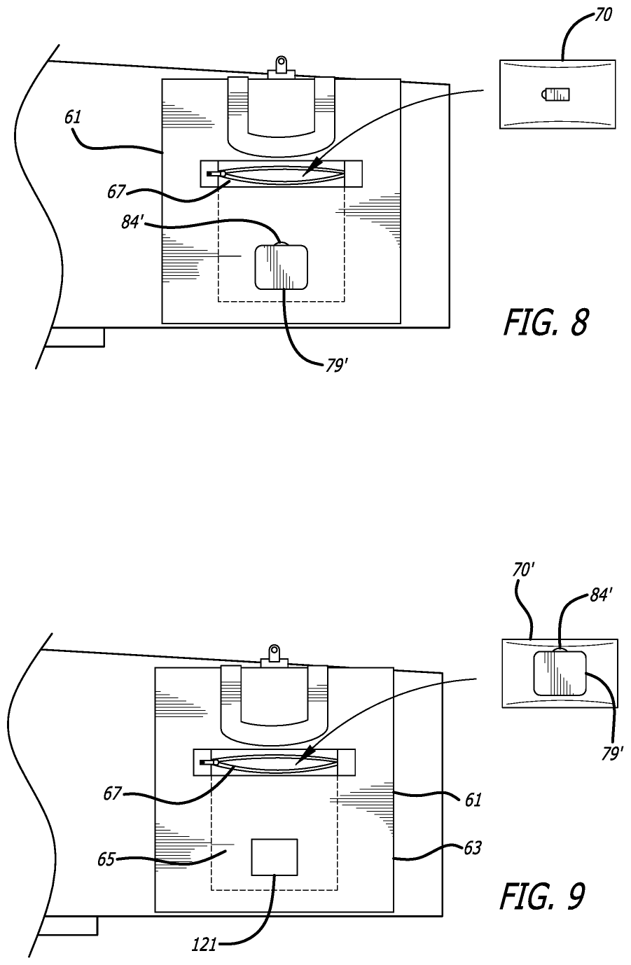

The pocket 65 includes a bottom wall 71 (FIG. 6) spaced a selected distance below the bottom edge of a window 73 in the front wall 63 and selectively covered by door 79 carried at the bottom by a hinge 81 and having a thumb tab 83 at the top end. The door includes a clasp 83 at the top for cooperating with a clasp element in the 82 at the top of the door 79. Referring FIGS. 7 and 8 in some embodiments the window 21 is surrounded by a rigid frame 80 to which the door is connected along is a bottom edge by a living, flexible plastic hinge 84. The frame is formed with rectangular a peripheral outwardly opening groove 90. The door is formed with a rectangular peripheral reinforcing flange 92 constructed for, when the door is closed, registering in the groove 90.

In this combination, the bag may be suspended from the side wall of a cart 91 (FIG. 7), the zipper opened for receipt of a tissue packet 95 to be supported in the pocket confronting the window for exposure of the packet and dispenser slot 96 for dispensing the tissue 98.

Thus, as the shopper is shopping he or she may wheel the cart 91 about the aisles of a grocery store or the like with the bag and tissue dispenser combination suspended from the sidewall by the clip 101 carrying the suspension rod 103 embedded at the top of the back wall of the shopping bag to maintain the top edge of the flexible shopping supported and draped from the rod 103 for convenient opening thereof to have access thereto. The top of the back wall is formed with sleeves 100 through which the rod 103 is threaded. Conveniently, the end walls of the bag are formed with a vertical centerfold line 111 which is weakened to form fold lines so that the bag may be folded in accordion fashion to collapse the front and back walls together for convenient compact storage thereof. In some embodiments, a number of such bags may be so collapsed and folded that a number thereof, for instance ten to fifteen folded bags, maybe received in one master bag 61 to provide for ready access to be individually displayed as the shopper maneuvers around the store. As the shopper continues to shop, the bags may be filled and supported in the shopping cart for presentation at the check-out counter. Conveniently, the thumb tab 83 may be accessed to open the door 79 to access the tissues carried in the tissue packet 70 for selective sequential dispensing thereof for sanitizing of the shopper's hands.

In some embodiments, a tether strap is supported on one end from the back wall with the free end having a patch of Velcro fastener which corporates with a fastener on the front wall for securing over the contents of the shopping to hold the items in place. This arrangement is helpful when the shopping bag is utilized for supporting a supply of shopping bags and might in some instances, be removed from the shopping cart and maneuvered about to transfer to the back seat or trunk of a user's automobile.

Referring to FIG. 8, in some embodiments the packet 70 is separate and includes a tissue compartment covered by a door 79 and which may be inserted in the pocket 65. The packet 70 is constructed with a transparent front wall 90 having a dispensing slit 96 formed therein. The packet is to be cooperatively received in the pocket 65 such that the door 79 is conveniently registered, with the window 121 in the front wall of the bag for ready access to the door 79 and thumb tab 84.

From the foregoing, it will be appreciated that the combination bag and tissue dispenser of the present invention provides an important and convenient health measure to encourage sanitation and cleanliness of the user's hands to minimize the spread germs, viruses, and the like. The pocket holds the tissue packet exposed to the users field of view and work so that dispensing of the tissues is suggested as bags are retrieved and the hands may be easily sanitized with each retrieval. The apparatus is environmentally friendly, encouraging reuse of the bags.

1. A combination shopping bag and tissue dispenser apparatus for suspension for the wall of a shopping cart for comprising:
a bag having top and bottom ends and including flexible front and back walls;
a suspension bar at the top of the back wall;
a hanger for hanging the suspension bar form the wall of the shopping cart;
a storage pocket behind the front wall for receiving a packet of tissue to dispense through a packet outlet; and
a door opening in the front wall to pass tissue dispensed from the packet outlet.

2. The combination shopping bag and tissue dispenser apparatus of claim 1 wherein:
the door opening is spaced a selected distance from the bottom of the pocket; and
the packet of tissue is configured with a bottom wall spaced the selected distance below the packet outlet.

3. The combination of claim 1 that includes:
a doorframe surrounding the door opening; and
a door hinged to one side to the frame for covering the doorway.

4. The combination of shopping bag and tissue dispenser of claim 3 that includes:
a clasp for fasting the door in its closed position.

5. The combination of claim 1 wherein:
the front wall includes a reinforcing border surrounding the doorway.

6. The combination of claim 1 that includes:
a fastener at the top of the pocket for closure thereof.

7. The combination of claim 1 wherein:
the walls are constructed of oil cloth fabric.

8. The combination of claim 1 wherein:
the walls are constructed of vinyl fabric.

9. Combination shopping bag and tissue dispenser apparatus for suspension from a wall of a shopping cart and comprising:
a bag having top and bottom ends and including front and back walls;
the front wall formed with a doorway;
a suspension bar incorporated at the top of the back wall;
a hanger for hanging the suspension bar from the wall of the shopping cart;
a storage pocket behind the front wall for receiving a packet of tissue of the type having an outlet to be disposed confronting the doorway for dispensing of tissue; and
a door hinged on one side to the front wall and the constructed to pivot between open and closed positions relative to the doorway.

10. The combination shopping bag and tissue dispenser apparatus of claim 9 wherein:
the packet includes a transparent wall formed with a dispenser outlet.

11. The combination shopping bag and tissue dispenser apparatus of claim 9 that includes:
a rigid frame surrounding the doorway; and
the door is hingedly attached to the frame.

12. The combination shopping bag and tissue dispenser apparatus of claim 9 that includes:
a rigid frame surrounding the doorway and formed with a peripheral, outwardly opening groove; and
a door hingedly connected to the frame and formed with a flange to, when the door is closed, be received in the groove.

13. A tissue packet device comprising:
an envelope to contain a supply of tissues, the envelope formed with an opening;
a rigid frame surrounding the opening and formed with a doorway;
a door hinged to the frame for covering and uncovering the opening.

14. The combination set forth in claim 13 wherein:
the frame is formed with a peripheral edge; and
the door includes a peripheral flange formed to, when the door is closed, frictionally engage the peripheral edge.

15. The combination set forth in claim 14 wherein:
a portion of the peripheral flange is cut away to from an opening to be engaged by a user's fingers for purchase to open the door.

16.-18. (canceled)
